(19) United States
(12) Patent Application Publication
(10) Pub. No.: US 2019/0007488 A1
(43) Pub. Date: Jan. 3, 2019

(54) DEVICE AND METHOD FOR PROVIDING CLOUD SERVICE

(71) Applicant: In Hye KIM, San Jose, CA (US)

(72) Inventor: In Hye KIM, San Jose, CA (US)

(21) Appl. No.: 16/025,234

(22) Filed: Jul. 2, 2018

(30) Foreign Application Priority Data
Jul. 3, 2017 (KR) 10-2017-0084427

(51) Int. Cl. H04L 29/08

(52) U.S. Cl. CPC H04L 67/1095; H04L 67/16; H04L 67/1097

(57) ABSTRACT

The present disclosure relates to a cloud service providing device and method. The cloud service providing device includes a body; a first connection unit formed in one face of the body, wherein a first storage unit is connectable to the first connection unit; a second connection unit formed in one face of the body, wherein a second storage unit is connectable to the second connection unit; a communication unit for performing communication with a user terminal; and a control unit for controlling the communication unit so that the first storage unit and the user terminal exchange data with each other when the first storage unit is connected to the first connection unit. In this way, data stored in an to existing storage unit into a separate storage unit according to a preset period may allow preventing data loss due to failure of the existing storage unit.

### CROSS-REFERENCE TO RELATED APPLICATIONS

This application claims the priority of Korean Patent Application No. 10-2017-0084427 filed on Jul. 3, 2017, in the Korean Intellectual Property Office, the disclosure of which is hereby incorporated by reference in its entirety.

### BACKGROUND

### 1. Technical Field

The present disclosure relates to a device and method for providing cloud service.

### 2. Description of the Related Art

Recently, with the improvement of hardware performance and the trend of increasing quality of data processed in hardware, the size of data processed in various digital devices such as PC or smart phone has increased. Various digital devices include a separate memory for storing data. The storage capacity of such memory has been continuously increasing with the development of hardware.

However, the capacity of the memory included in the digital device is limited. Thus, when data is accumulated continuously in a large amount of memory, all of the accumulated all of data may not be sufficiently stored in the large amount of memory. In recent years, the use of cloud services has become commonplace to solve the problem of insufficient memory capacity.

In the example of using a cloud service, there is a method of storing and managing the user's data using a server of an external company providing the cloud service. More specifically, the cloud service user may pay the external company providing the cloud service based on the storage period and capacity of data, and may store personal data in a storage space allocated by the company. The user may access his/her data via the user terminal without restriction of location and time.

When the user use a cloud service provided by an outside company, it has the advantage of storing a large amount of data without using a separate personal data storage unit. However, in order to store a large amount of data in the server of the external company, the user must pay a high usage fee, and, further, there is a possibility that a leak of personal data may occur due to a hacking against an external company's server.

In another example of using the cloud service, there is a method for storing and managing data using a personal cloud device. A user of the personal cloud device may place the cloud device in a personal space, such as his or her home or office. The users may store and manage data by connecting to the cloud device using wired/wireless communication.

With such a personal cloud device, the user does not have to pay additional fees, such as cloud service fees, excluding the cost of purchasing the cloud device. In addition, the user may disconnect the communication connection of the personal cloud device from spaces other than the private space, thereby preventing leakage of the personal data due to hacking.

However, if a failure occurs in the storage unit of the personal cloud device, loss of stored data may occur. The user may have inconvenience that the data is not stored and managed via the cloud device until the failed storage unit has been repaired. Further, in order to recover the lost data due to the failure of the storage unit, the user should entrust the storage unit with an external data recovery company. This may lead to a problem that personal data may leak out.

### SUMMARY

One purpose of the present disclosure is intended to provide a cloud service providing device and method, in which storing data stored in an existing storage unit in a separate storage unit according to a preset period may allow preventing data loss due to failure of the existing storage unit.

In addition, another purpose of the present disclosure is intended to provide a cloud service providing device and method, in which when a failure occurs in the existing storage unit, data may be stored directly in a separate storage unit, thereby to perform the data storage function at any time.

In addition, still another purpose of the present disclosure is intended to provide a cloud service providing device and method, in which when a failure of the existing storage unit is restored, data stored in the separate storage unit is stored in the existing storage unit, thereby, to recover the data of the existing storage unit without a help from an external device or company.

The purposes of the present disclosure are not limited to the above-mentioned purposes, and other purposes and advantages of the present disclosure which are not mentioned above may be understood from following descriptions. Further, it will be readily appreciated that the purposes and advantages of the present disclosure may be realized by features and combinations thereof, as set forth in the claims.

In one aspect of the present disclosure, there is provided a cloud service providing device comprising: a body; a first connection unit formed in one face of the body, wherein a first storage unit is connectable to the first connection unit; a second connection unit formed in one face of the body, wherein a second storage unit is connectable to the second connection unit; a communication unit for performing communication with a user terminal; and a control unit for controlling the communication unit so that the first storage unit and the user terminal exchange data with each other when the first storage unit is connected to the first connection unit, wherein the control unit is configured: when the second storage unit is connected to the second connection unit while the first storage unit is connected to the first connection unit, for controlling the first storage unit and the second storage unit to be synchronized with each other; when the connection between the first storage unit and the first connection unit is disabled and, subsequently, the first storage unit is connected to the first connection unit again, for allowing data stored in the second storage unit for a duration to be stored into the first storage unit, wherein the duration is between a point of time when the connection between the first storage unit and the first connection unit is disabled and a point of time when the first storage unit is connected to the first connection unit again.

In another aspect of the present disclosure, there is provided a cloud service providing method comprising: when a first storage unit is connected to a first connection unit, controlling a communication unit so that the first storage unit and an user terminal exchange data with each other; when a second storage unit is connected to a second connection unit while the first storage unit is connected to the first connection unit, controlling the first storage unit and the second storage unit to be synchronized with each other; and when the connection between the first storage unit and the first connection unit is disabled and, subsequently, the first storage unit is reconnected to the first connection unit, allowing data stored in the second storage unit for a duration to be stored into the first storage unit, wherein the duration is between a point of time when the connection between the first storage unit and the first connection unit is disabled and a point of time when the first storage unit is connected to the first connection unit again.

In accordance with the present disclosure, storing data stored in an existing storage unit into a separate storage unit according to a preset period may allow preventing data loss due to failure of the existing storage unit.

In addition, in accordance with the present disclosure, when a failure occurs in the existing storage unit, data may be stored directly in a separate storage unit, thereby to perform the data storage function at any time.

In addition, when a failure of the existing storage unit is restored, data stored in the separate storage unit is stored in the existing storage unit, thereby, to recover the data of the existing storage unit without a help from an external device or company.

The effects of the present disclosure may not limited thereto but other effects may be apparent from following descriptions.

### BRIEF DESCRIPTION OF DRAWINGS

FIG. 1 is a block diagram schematically illustrating a cloud service providing device according to one embodiment of the present disclosure.

FIG. 2 is a perspective view illustrating a structure of a cloud service providing device according to one embodiment of the present disclosure.

FIG. 3 is a perspective view showing a structure of a cloud service providing device according to another embodiment of the present disclosure.

FIG. 4 shows a cloud service providing process according to one embodiment of the present disclosure.

FIG. 5 is a block diagram illustrating controlling a second user terminal via a cloud service providing device according to one embodiment of the present disclosure.

### DETAILED DESCRIPTION

The above objects, features and advantages will become apparent from the detailed description with reference to the accompanying drawings. Embodiments are described in sufficient detail to enable those skilled in the art in the art to easily practice the technical idea of the present disclosure. Detailed descriptions of well-known functions or configurations may be omitted in order not to unnecessarily obscure the gist of the present disclosure. Hereinafter, embodiments of the present disclosure will be described in detail with reference to the accompanying drawings. Throughout the drawings, like reference numerals refer to like elements.

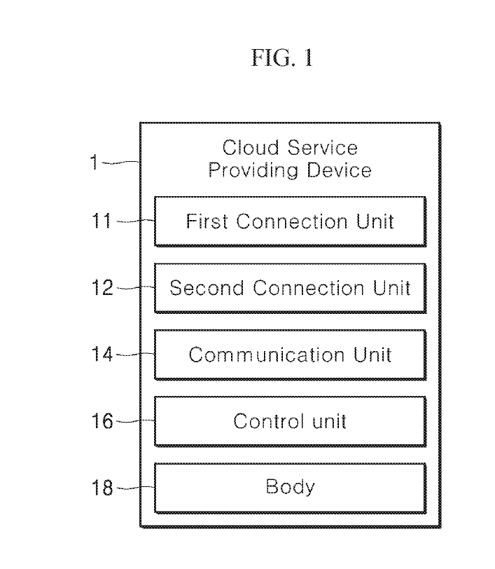

FIG. 1 is a block diagram schematically illustrating a cloud service providing device according to one embodiment of the present disclosure.

Referring to FIG. 1, a cloud service providing device 1 according to one embodiment of the present disclosure includes a first connection unit 11, a second connection unit 12, a communication unit 14, a control unit 16 and a body 18.

The first connection unit 11 is formed in one side portion of the body 18 and connected to the first storage unit. The first storage unit is a data storage unit for storing data from a user terminal.

For example, the first storage unit may be embodied as a hard disk drive (HDD) that stores data on a magnetic disk, or a solid state drive (SSD) that stores data in a semiconductor memory.

A type of the data storage unit used as the first storage unit may vary depending on a size and type of the stored data therein.

The second connection unit 12 is formed in one side potion of the body 18 and connected to a second storage unit. The second storage unit is a data storage unit for backing up the data stored in the first storage unit.

In one embodiment of the present disclosure, the second storage unit, like the first storage unit may be embodied as a hard disk drive (HDD) that stores data on a magnetic disk, or a solid state drive (SSD) that stores data in a semiconductor memory.

A type of the data storage unit used as the second storage unit may vary depending on a size and type of the data stored therein.

In one embodiment of the present disclosure, two or more second connection units 12 may be formed in one side potion of the body 18. In this connection, the two or more second connection units 12 may be respectively connected to two or more second storage units.

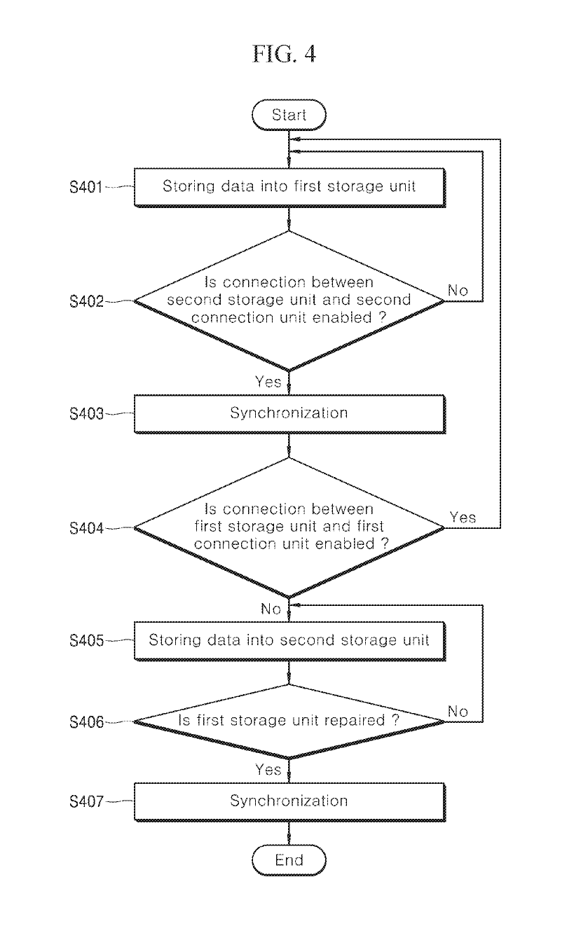

That is, the cloud service providing device in accordance with the present disclosure may back up the data from the first storage unit using the at least two second storage units. In this way, when the two or more second storage units are used, the cloud service providing process as described below with reference to FIG. 4 may be performed independently for each of the two or more second storage units.

The communication unit 14 communicates with the user terminal. When the first storage unit is connected to the first connection unit 11, the communication unit transfers data between the first storage unit and the user terminal. Similarly, when the second storage unit is connected to the second connection unit 12, the communication unit 14 transfers data between the second storage unit and the user terminal.

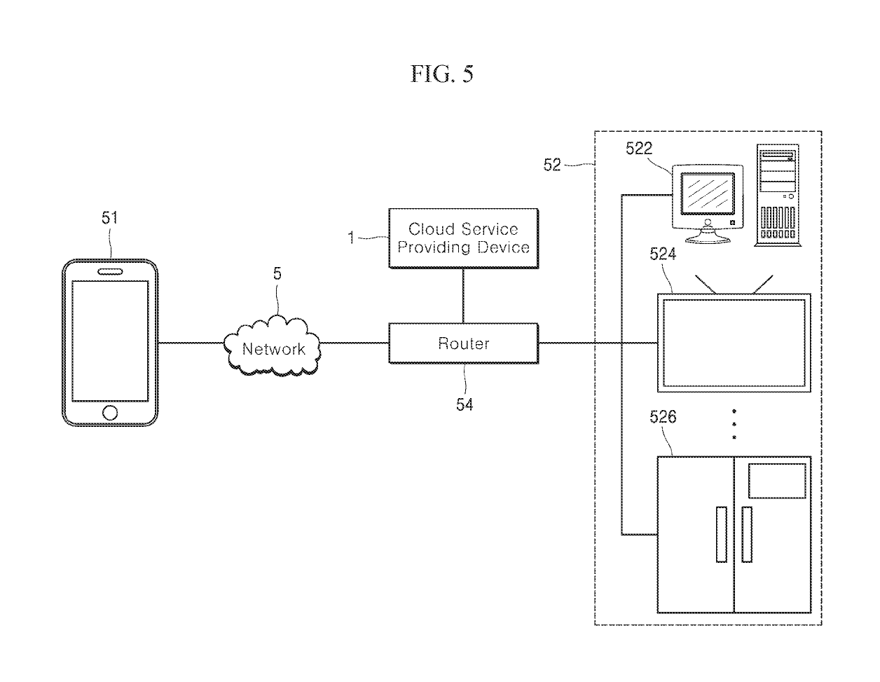

In one embodiment of the present disclosure, the communication unit 14 may communicate data with a user terminal using wired or wireless communication. In one example, the communication unit 14 may communicate with the user terminal using wireless communications including WLAN Wireless (LAN), Wi-Fi, Wibro and Bluetooth protocols. In another example, the communication unit 14 may communicate with the user terminal using wired communications, including a LAN protocol. In this connection, the user terminal performing communication with the communication unit 14 may include both a first user terminal 51 and a second user terminal 52, which will be described later with reference to FIG. 5.

In one embodiment of the present disclosure, the communication protocol used by the communication unit 14 may vary depending on a distance between the user terminal and the cloud service providing device 1, a location of the cloud service providing device 1, or performances of the user terminal and cloud service providing device 1.

The control unit 16 controls the communication unit 14 such that when the first storage unit is connected to the first connection unit 11, the first storage unit and the user terminal exchange data with each other.

In one embodiment of the present disclosure, the control unit 16 may store data from the user terminal into the first storage unit in real time. That is, the first storage unit may perform a real-time backup function of the data stored in the user terminal.

For example, the data stored in the first storage unit may remain the same as the data stored in the user terminal. That is, when new data is stored in the user terminal, the same new data may be stored in the first storage unit. When data stored in the user terminal is deleted, the same data stored in the first storage unit may also be deleted.

In another example, the first storage unit may continuously accumulate therein data as received from the user terminal. That is, when new data is stored in the user terminal, the same new data may be stored in the first storage unit. However, in this case, even when the data stored in the user terminal is deleted, the same data stored in the first storage unit may not be deleted.

In one embodiment of the present disclosure, the control unit 16 may store data of the user terminal in the first storage unit according to a predetermined period. For example, the predetermined period may be 1 hour. In this case, when the first storage unit is connected to the first connection unit 11, the control unit 16 may control the present service providing device so that the data of the user terminal is stored in the first storage unit every hour. In this way, the data stored in the first storage unit may be updated with the same data as the data stored in the user terminal every hour.

In one embodiment of the present disclosure, the control unit 16 may store the data of the user terminal in the first storage unit only when there is a request from the user. That is, the user may directly select data to be stored in the first storage unit and the storage timing of the data to be stored, and then request the storage of the data. In this case, the control unit 16 may store the data of the user terminal as selected by the user into the first storage unit in response to the request of the user.

In one embodiment of the present disclosure, the user may check contents of the data stored in the first storage unit via the user terminal. For example, when a photo file is stored in the first storage unit, the control unit 16 may display the photo file stored in the first storage unit on a screen of the user terminal in response to the user's request. In another example, when a music file is stored in the first storage unit, the control unit 16 may play the music file stored in the first storage unit via the user terminal in response to a user's request.

The control unit may detect that the second storage unit is connected to the second connection unit 12 while the first storage unit is connected to the first connection unit 11. In this response, the control unit 16 controls the service providing device such that the first storage unit and the second storage unit are synchronized with each other. In this connection, the synchronization between the first storage unit and the second storage unit means that the same data as the data stored in the first storage unit is stored in the second storage unit.

In one embodiment of the present disclosure, the control unit 16 may store data of the first storage unit in the second storage unit such that the data stored in the second storage unit is the same as the data stored in the first storage unit. That is, the second storage unit may perform a backup function of the data stored in the first storage unit.

The control unit 16 may synchronize the first storage unit and the second storage unit according to a preset determined. In one embodiment of the present disclosure, the control unit 16 may store the data of the first storage unit in the second storage unit according to the predetermined period. For example, the predetermined period may be one hour. In this case, the control unit 16 may store the data of the first storage unit in the second storage unit every one hour. Therefore, the data stored in the second storage unit may be updated with the same data as the data stored in the first storage unit every hour.

Therefore, even when a failure of the first storage unit occurs and, thus, the data stored in the first storage unit is damaged, the user may use the data of the first storage unit as stored in the second storage unit. Particularly, as described above, the present disclosure may be configured such that the data stored in the first storage unit is always kept the same as the data stored in the user terminal. In this case, when all data of the user terminal and the first storage unit may be deleted, the user may use the data of the first storage unit as stored in the second storage unit.

That is, the cloud service providing device of the present disclosure has an advantage of preventing loss of data due to failure of the first storage unit by storing the data stored in the first storage unit into the second storage unit according to a predetermined period.

When it is detected that the second storage unit is connected to the second connection unit 12 while the first storage unit is connected to the first connection unit 11, the control unit 16 controls the communication unit 14 so that the second storage unit and the user terminal exchange data with each other.

That is, the control unit 16 may control the communication unit 14 in response to a user request so that the second storage unit and the user terminal exchange data with each other. Accordingly, the user may check, modify or delete data stored in the second storage unit via the user terminal.

While the first storage unit is connected to the first connection unit 11 and the second storage unit is connected to the second connection unit 12, it may be confirmed that the connection between the first storage unit and the first connection unit is disabled. In response, the control unit 16 controls the communication unit 14 so that the second storage unit and the user terminal exchange data with each other.

According to the present disclosure, disabling of the connection between the first connection unit 11 and the first storage unit may occur when the user disconnects the first storage unit from the first connection unit 11 or when a failure occurs in the first storage unit and, thus, the data of the user terminal cannot be normally stored in the first storage unit.

In one embodiment of the present disclosure, when the connection between the first connection unit 11 and the first storage unit is disabled, the control unit 16 may control the present device so that the data of the user terminal is stored in the second storage unit instead of the first storage unit. That is, when the connection between the first connection unit 11 and the first storage unit is disabled, the second storage unit may perform the backup function as otherwise performed by the first storage unit.

In this way, the cloud service providing device of the present disclosure has the advantage of being able to perform continuous data storage function via storing of the data in the second storage unit when a failure occurs in the first storage unit.

When the first storage unit is reconnected to the first connection unit 11, the control unit 16 refers to operation information of the second storage unit and, then, synchronizes the first storage unit and the second storage unit based on the referred information. In this connection, the synchronization between the first storage unit and the second storage unit may mean that the same data as that stored in the second storage unit while the connection between the first connection unit 11 and the first storage unit is disabled is stored in the first storage unit.

In this connection, the operation information of the second storage unit may include information about data stored in the second storage unit at following timings: a time when a connection between the first storage unit and the first connection unit is disabled; a time when a connection between the first storage unit and the first connection unit is enabled again; or a duration between a point of time when the connection between the first storage unit and the first connection unit is disabled and a point of time when the first storage unit is connected to the first connection unit again.

In one embodiment of the present disclosure, the reconnection between the first storage unit and the first connection unit 11 may occur when the user directly connects the first storage unit to the first connection unit 11 or when the first storage unit that failed is recovered.

In one embodiment of the present disclosure, once the first storage unit is reconnected to the first connection unit 11, the control unit 16 may store the data stored in the second storage unit into the first storage unit such that the data stored in the first storage unit is the same as the data stored in the second storage unit. That is, while the connection between the first storage unit and the first connection unit is disabled, the second storage unit may perform a backup function in place of the first storage unit. Then, when the first storage unit is again connected to the first connection unit 11, the data stored in the second storage unit while the connection between the first connection unit 11 and the first storage unit is disabled may be re-stored in the first storage unit.

In this connection, in order to store the data stored in the second storage unit into the first storage unit, the control unit 16 may store the operation information of the second storage unit. The operation information may include information about data stored in the second storage unit at following timings: a time when a connection between the first storage unit and the first connection unit is disabled; a time when a reconnection between the first storage unit and the first connection unit is enabled; or a duration between a point of time when the connection between the first storage unit and the first connection unit is disabled and a point of time when the first storage unit is connected to the first connection unit again.

The control unit 16 may store the data of the second storage unit into the first storage unit with referring to the stored operation information of the second storage unit. That is, when the connection between the first connection unit 11 and the first storage unit is disabled and, then, the first connection unit 11 and the first storage unit are reconnected to each other, the control unit 16 refers to the operation information of the second storage unit to store the data stored in the second storage unit into the first storage unit. That is, the control unit 16 may store into the first storage unit, the data stored in the second storage unit at following timings: a point of time when a reconnection between the first storage unit and the first connection unit is enabled; and a duration between a point of time when the connection between the first storage unit and the first connection unit is disabled and a point of time when the first storage unit is connected to the first connection unit again.

Eventually, the cloud service providing device of the present disclosure has the advantage of recovering the data of the first storage unit by itself by storing, upon detection that the failure of the first storage unit is recovered, into the first storage unit the data stored in the second storage unit while the failure of the first storage unit occurs.

As described above, the first connection unit 11 and the second connection unit 12 are disposed in one side portion of the body 18. In one embodiment of the present disclosure, the communication unit 14 and the control unit 16 may be disposed inside the body 18.

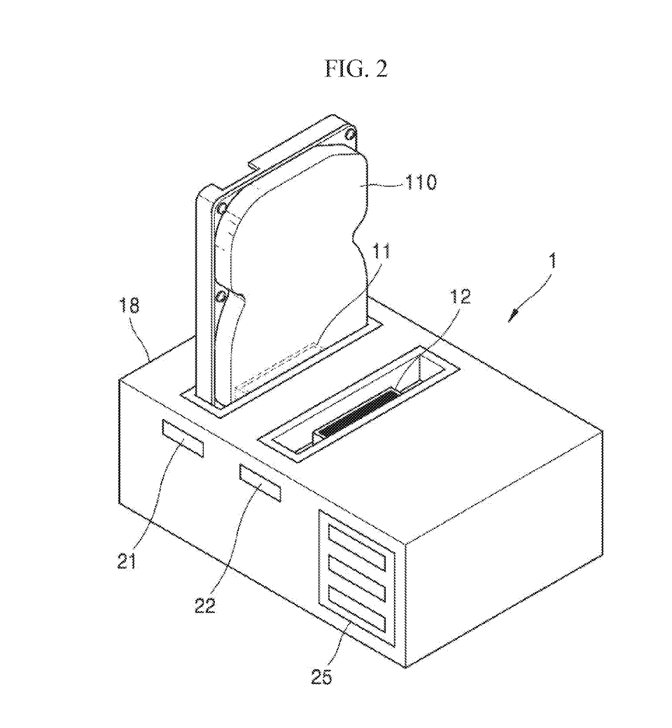

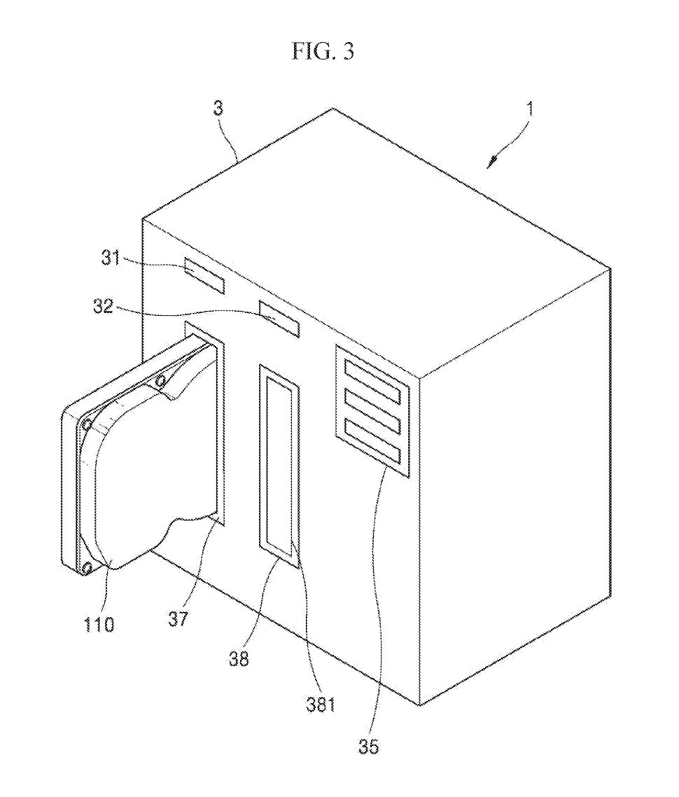

Hereinafter, a structure of a cloud service providing device according to an embodiment of the present disclosure will be described with reference to FIGS. 2 and 3.

FIG. 2 is a perspective view illustrating a structure of a cloud service providing device according to one embodiment of the present disclosure.

Referring to FIG. 2, a cloud service providing device 1 according to one embodiment of the present disclosure may have the first connection unit 11 and second connection unit 12 defined in the upper portion of the body 18. The first connection unit 11 and the second connection unit 12 may be implemented as first and second slots into which the first storage unit and the second storage unit may be inserted, respectively. Referring again to FIG. 2, the first storage unit 110 is inserted into the slot-shaped first connection unit 11, and the second connection unit 12 is separated from the second storage unit.

Although not shown in FIG. 2, as described above, the cloud service providing device 1 according to one embodiment of the present disclosure may include two or more second connection units 12 defined within one side portion of the body 18.

That is, the user may easily achieve connection or separation between the storage unit and the connection unit by using the connection unit having a slot shape. Accordingly, when a failure occurs in the storage unit or data cannot be stored in the storage unit, the user removes the existing storage unit and inserts a new storage unit into the corresponding connection unit. This makes it easy to replace the storage unit.

In one embodiment of the present disclosure, a manipulation interface 25 may be disposed on one side of the body 18. The user may enter, via the manipulation interface 25, commands for moving or copying of data between the first storage unit and the second storage unit or for deleting data stored in the first storage unit and the second storage unit. Although not shown in FIG. 2, the control unit 16 and the communication unit 14 may be located inside the body 18.

Referring again to FIG. 2, the cloud service providing device 1 according to one embodiment of the present disclosure includes a first storage unit state display unit 21 and a second storage unit state display unit 22 disposed on one side face of the body 18. The control unit 16 controls an illumination unit included in each of the first storage unit state display unit 21 and the second storage unit state display unit 22 to display an operation state of each of the first storage unit and the second storage unit.

FIG. 3 is a perspective view showing a structure of a cloud service provider device according to another embodiment of the present disclosure.

Referring to FIG. 3, a cloud service providing device 1 according to another embodiment of the present disclosure may further include an outer casing 3.

Although not shown in the drawings, the outer casing 3 may also house the above-described body 18 with reference to FIG. 2.

The outer casing 3 may protect the body 18 and the storage unit from contaminants and external impacts.

A first insertion opening 37 and second insertion opening 38 may be defined in one face portion of the outer casing 3. In this connection, the first storage unit is inserted into the first opening 37. The first storage unit may be connected to the first connection unit 11 defined in one side of the body 18 through the first opening 37. Similarly, the second storage unit is inserted into the second opening 38. The second storage unit may be connected to the second connection unit 12 formed in one side of the body 18 through the second opening 38. In this connection, the first insertion opening 37 and the second insertion opening 38 may retain the first storage unit and the second storage unit connected to the first connection unit 11 and the second connection unit 12 respectively.

As described above, the cloud service providing device 1 according to one embodiment of the present disclosure may include two or more second connection units 12 defined in one side portion of the body 18. Thus, although not shown in FIG. 3, the same number of second insertion openings 38 as the number of the two or more second connection units 12 may be defined in the side face portion of the outer casing 3.

As described above with reference to FIG. 2, each of the first connection unit 11 and the second connection unit 12 may have a slot shape into which the first storage unit and second storage unit are inserted respectively. That is, the user inserts each storage unit through each insertion opening in the outer casing 3. In this way, the corresponding storage unit and slot-type connection unit may be easily connected to each other or disconnected from each other.

Referring back to FIG. 3, the first storage unit 110 is inserted through the first opening 37. In one embodiment, although not shown in FIG. 3, the second storage unit may be inserted through the second opening 38 to be connected to the second connection unit 12. The second insertion opening 38 is closed by a cover 381. That is, when the storage unit is completely inserted through the insertion opening and then connected to the connection unit, the insertion opening may he closed by the cover 381. The cover 381 prevents external contaminants from entering into the outer casing 3 and protects the storage unit from external impacts.

In one embodiment of the present disclosure, a manipulation interface 35 may be disposed on one side of the outer casing 3. The user may enter a command to move data or copy between the first storage unit and the second storage unit via the manipulation interface 35, or enter a command to delete the data stored in the first storage unit and the second storage unit via the manipulation interface 35.

Referring again to FIG. 3, the cloud service providing device 1 according to one embodiment of the present disclosure includes a first storage unit state display unit 31 and a second storage unit state display unit 32 disposed on one side face of the outer casing 3. The control unit 16 may display an operation state of each of the first storage unit and a second storage unit via control of an illumination unit included in each of the first storage unit state display unit 31 and the second storage unit state display unit 32.

Hereinafter, referring to FIG. 4, a cloud service providing method according to one embodiment of the present disclosure is illustrated in detail.

FIG. 4 shows a cloud service providing process according to one embodiment of the present disclosure.

First, when the first storage unit is connected to the first connection unit 11, the control unit 16 controls the communication unit 14 so that the first storage unit and the user terminal exchange data with each other. In this way, the data of the user terminal is stored in the first storage unit (S401).

As described above, in one embodiment of the present disclosure, the control unit 16 may store the data of the user terminal in the first storage unit in real time. That is, the first storage unit may perform a real-time backup function of data stored in the user terminal.

In one embodiment of the present disclosure, the data stored in the first storage unit may remain the same as the data stored in the user terminal. That is, when new data is stored in the user terminal, the same new data may be stored in the first storage unit. When data stored in the user terminal is deleted, the same data stored in the first storage unit may also be deleted.

In another embodiment, the first storage unit may continuously accumulate therein data as received from the user terminal. That is, when new data is stored in the user terminal, the same new data may be stored in the first storage unit. However, in this case, even when the data stored in the user terminal is deleted, the same data stored in the first storage unit may not be deleted.

In one embodiment of the present disclosure, the control unit 16 may store data of the user terminal in the first storage unit according to a predetermined period. In another embodiment of the present disclosure, the control unit 16 may store the data of the user terminal in the first storage unit only when there is a request from the user. That is, the user may directly select data to be stored in the first storage unit and the storage timing of the data to be stored, and then request the storage of the data. In this case, the control unit 16 may store the data of the user terminal as selected by the user into the first storage unit in response to the request of the user.

Next, the control unit 16 determines whether or not the second storage unit is connected to the second connection unit 12 while the first storage unit is connected to the first connection unit 11 (S402).

If it is determined from the determination result S402 that the second storage unit is connected to the second connection unit 12, the control unit 16 performs synchronization between the first storage unit and the second storage unit (S403). In this connection, the control unit 16 performs synchronization between the first storage unit and the second storage unit according to a predetermined period. In this connection, the synchronization between the first storage unit and the second storage unit means that the same data as the data stored in the first storage unit is stored in the second storage unit.

In one embodiment of the present disclosure, the control unit 16 may store data of the first storage unit in the second storage unit such that the data stored in the second storage unit is the same as the data stored in the first storage unit. That is, the second storage unit may perform a backup function of the data stored in the first storage unit.

In one embodiment of the present disclosure, the control unit 16 may synchronize the first storage unit and the second storage unit according to a preset determined. The control unit 16 may store the data of the first storage unit in the second storage unit according to the predetermined period.

In this way, the cloud service providing device of the present disclosure has an advantage of preventing loss of data due to failure of the first storage unit by storing the data stored in the first storage unit into the second storage unit according to a predetermined period.

Conversely, if it is determined from the determination result S402 that the second storage unit is not connected to the second connection unit 12, the control unit 16 controls the communication unit 14 so that the first storage unit and the user terminal exchange data with each other continuously. Thus, the data of the user terminal may be stored in the first storage unit. That is, the first storage unit may continuously perform the real-time backup function of the data stored in the user terminal.

Then, while the first storage unit is connected to the first connection unit 11 and the second storage unit is connected to the second connection unit 12, the control unit 16 determines whether connection between the first storage unit and the first connection unit is disabled (S404).

It is determined from the determination result S404 that the connection between the first storage unit and the first connection unit is not disabled, the control unit 16 controls the communication unit 14 so that the first storage unit and the user terminal continuously exchange data with each other, thereby to store the data of the user terminal in the first storage unit.

Conversely, it is determined from the determination result S404 that the connection between the first storage unit and the first connection unit is disabled, the control unit 16 controls the communication unit 14 so that the second storage unit and the user terminal exchange data with each other, thereby storing the data of the user terminal in the second storage unit in step (S405).

As used herein, as mention above, disabling of the connection between the first connection unit 11 and the first storage unit may occur when the user disconnects the first storage unit from the first connection unit 11 or when a failure occurs in the first storage unit and, thus, the data of the user terminal cannot be normally stored in the first storage unit.

In one embodiment of the present disclosure, when the connection between the first connection unit 11 and the first storage unit is disabled, the data of the user terminal is stored in the second storage unit instead of the first storage unit. That is, when the connection between the first connection unit 11 and the first storage unit is disabled, the second storage unit may perform the backup function as otherwise performed by the first storage unit. In this way, the cloud service providing device of the present disclosure has the advantage of being able to perform continuous data storage function via storing of the data in the second storage unit when a failure occurs in the first storage unit.

Subsequently, the control unit 16 determines whether the first storage unit is re-connected to the first connection unit 11 (S406).

When it is determined from the determination result S406 that the first storage unit is not re-connected to the first connection unit 11, the control unit 16 controls the communication unit 14 so that the second storage unit and the user terminal continue to exchange data with each other, thereby storing the data of the user terminal in the second storage unit.

Conversely, when it is determined from the determination result S406 that the first storage unit is re-connected to the first connection unit 11, the control unit 16 refers to operation information of the second storage unit and, then, synchronizes the first storage unit and the second storage unit based on the referred information (S407). In this connection, the synchronization between the first storage unit and the second storage unit may mean that the same data as that stored in the second storage unit while the connection between the first connection unit 11 and the first storage unit is disabled is stored in the first storage unit.

In one embodiment of the present disclosure, the reconnection between the first storage unit and the first connection unit 11 may occur when the user directly connects the first storage unit to the first connection unit 11 or when the first storage unit that failed is recovered.

As mentioned above, the operation information of the second storage unit may include information about data stored in the second storage unit at following timings: a time when a connection between the first storage unit and the first connection unit is disabled; a time when a reconnection between the first storage unit and the first connection unit is enabled; or a duration between a point of time when the connection between the first storage unit and the first connection unit is disabled and a point of time when the first storage unit is connected to the first connection unit again.

In one embodiment of the present disclosure, once the first storage unit is reconnected to the first connection unit 11, the control unit 16 may store the data stored in the second storage unit into the first storage unit such that the data stored in the first storage unit is the same as the data stored in the second storage unit. That is, while the connection between the first storage unit and the first connection unit is disabled, the second storage unit may perform a backup function in place of the first storage unit. Then, when the first storage unit is reconnected to the first connection unit 11, the data stored in the second storage unit while the connection between the first connection unit 11 and the first storage unit is disabled may be re-stored in the first storage unit.

That is, the cloud service providing device of the present disclosure has the advantage of recovering the data of the first storage unit by itself by storing, upon detection that the failure of the first storage unit is recovered, into the first storage unit the data stored in the second storage unit while the failure of the first storage unit occurs.

FIG. 5 shows a block diagram of controlling a second user terminal 52 via a cloud service providing device according to one embodiment of the present disclosure. According to the present disclosure, the second user terminal 52 is a separate terminal that the user may control using a first user terminal 51.

Referring to FIG. 5, in one embodiment of the present disclosure, the first user terminal 51 may be connected to a router 54 via a network 5. In this connection, the router 54 may be connected to the communication unit 14 of the cloud service providing device and second user terminal 52. That is, the router 54 may transmit data between the first user terminal 51, the second user terminal 52, and the cloud service providing device 1.

Referring again to FIG. 5, the first user terminal 51 may be implemented as a smartphone including an interface. The second user terminal 52 may be implemented as a digital device having memory means such as a computer 522, a smart TV 524, and a smart refrigerator 526. The second user terminal 52 may be connected to the router 54 and, hence, may exchange data with the cloud service providing device 1 and the first user terminal 51.

In one embodiment of the present disclosure, the control unit 16 may perform control of the second user terminal 52 in response to a user request via the first user terminal 51.

For example, when the user requests, via the first user terminal 51, to transmit data stored in the first storage unit or the second storage unit to the computer 522, which is the second user terminal 52, the control unit 16 may transmit, via the router 54, data stored in the first storage unit or the second storage unit as requested to the computer 522, which is the second user terminal 52.

In another example, when the user requests, via the first user terminal 51, playback of a moving picture file stored in the first storage unit or the second storage unit by the smart TV 524, which is the second user terminal 52, the control unit 16 may control, via the router 54, the smart TV 524 as the second user terminal 52 to play the moving picture file stored in the first storage unit or the second storage unit as requested.

That is, the control unit 16 may control the second user terminal 52 in response to the user request. Further, in order to control the second user terminal 52, the control unit may use data stored in the first storage unit or the second storage unit.

The detailed advantageous effects according to the present disclosure as well as the aforementioned effect have described above with regard to the embodiments of the present disclosure. The present disclosure described above may be variously substituted, altered, and modified by those skilled in the art to which the present disclosure pertains without departing from the scope and sprit of the present disclosure. Therefore, the present disclosure is not limited to the above-mentioned exemplary embodiments and the accompanying drawings.

What is claimed is:

1. A cloud service providing device comprising:
a body;
a first connection unit formed in one face of the body, wherein a first storage unit is connectable to the first connection unit;
a second connection unit formed in one face of the body, wherein a second storage unit is connectable to the second connection unit;
a communication unit for performing communication with a user terminal; and
a control unit for controlling the communication unit so that the first storage unit and the user terminal exchange data with each other when the first storage unit is connected to the first connection unit,
wherein the control unit is configured:
when the second storage unit is connected to the second connection unit while the first storage unit is connected to the first connection unit, for controlling the first storage unit and the second storage unit to be synchronized with each other;
when the connection between the first storage unit and the first connection unit is disabled and, subsequently, the first storage unit is connected to the first connection unit again, for allowing data stored in the second storage unit for a duration to be stored into the first storage unit, wherein the duration is between a point of time when the connection between the first storage unit and the first connection unit is disabled and a point of time when the first storage unit is connected to the first connection unit again.

2. The cloud service providing device of claim 1, wherein when the first storage unit is connected to the first connection unit and the second storage unit is connected to the second connection unit, the control unit is configured for controlling the communication unit such that the second storage unit and the user terminal exchange data with each other.

3. The cloud service providing device of claim 1, wherein the control unit is configured for controlling the first storage unit and the second storage unit to be synchronized with each other on a predetermined period basis.

4. The cloud service providing device of claim 1, wherein upon detection that the connection between the first storage unit and the first connection unit is disabled while the first storage unit is connected to the first connection unit and the second storage unit is connected to the second connection unit, the control unit is configured for controlling the communication unit so that the second storage unit and the user terminal exchange data with each other.

5. The cloud service providing device of claim 4, wherein upon detection that the first storage unit is reconnected to the first connection unit, the control unit is configured for referring to operation information of the second storage unit and for controlling the first storage unit and the second storage unit to be in synchronization with each other based on the operation information.

6. The cloud service providing device of claim 5, wherein the operation information of the second storage unit includes:
information about data stored in the second storage unit:
at a time point when a connection between the first storage unit and the first connection unit is disabled;
at a time point when a reconnection between the first storage unit and the first connection unit is enabled; and
for a duration between a point of time when the connection between the first storage unit and the first connection unit is disabled and a time point when the first storage unit and the first connection unit are reconnected to each other.

7. The cloud service providing device of claim 1, wherein the control unit is configured for controlling a second user terminal in response to a request from a first user terminal.

8. The cloud service providing device of claim I, wherein the second connection unit includes at least two second connection units formed in one face of the body, wherein the at least two second connection units are respectively connected to at least two second storage units.

9. A cloud service providing method comprising:
when a first storage unit is connected to a first connection unit, controlling a communication unit so that the first storage unit and an user terminal exchange data with each other;
when a second storage unit is connected to a second connection unit while the first storage unit is connected to the first connection unit, controlling the first storage unit and the second storage unit to be synchronized with each other; and
when the connection between the first storage unit and the first connection unit is disabled and, subsequently, the first storage unit is reconnected to the first connection unit, allowing data stored in the second storage unit for a duration to be stored into the first storage unit, wherein the duration is between a point of time when the connection between the first storage unit and the first connection unit is disabled and a point of time when the first storage unit is connected to the first connection unit again.

10. The cloud service providing method of claim 9, wherein when the first storage unit is connected to the first connection unit and the second storage unit is connected to the second connection unit, controlling the communication unit such that the second storage unit and the user terminal exchange data with each other.

11. The cloud service providing method of claim 9, wherein controlling the first storage unit and the second storage unit to be synchronized with each other includes controlling the first storage unit and the second storage unit to be synchronized with each other on a predetermined period basis.

12. The cloud service providing method of claim 9, further comprising: upon detection that the connection between the first storage unit and the first connection unit is disabled while the first storage unit is connected to the first connection unit and the second storage unit is connected to the second connection unit, controlling the communication unit so that the second storage unit and the user terminal exchange data with each other.

13. The cloud service providing method of claim 12, further comprising: upon detection that the first storage unit is reconnected to the first connection unit, referring to operation information of the second storage unit and controlling the first storage unit and the second storage unit to be in synchronization with each other based on the operation information.

14. The cloud service providing method of claim 13, wherein the operation information of the second storage unit includes:
information about data stored in the second storage unit:
at a time point when a connection between the first storage unit and the first connection unit is disabled;
at a time point when a reconnection between the first storage unit and the first connection unit is enabled; and
for a duration between a point of time when the connection between the first storage unit and the first connection unit is disabled and a time point when the first storage unit and the first connection unit are reconnected to each other.

15. The cloud service providing method of claim 9, further comprising controlling a second user terminal in response to a request from a first user terminal.

16. The cloud service providing method of claim 9, wherein the second connection unit includes at least two second connection units formed in one face of the body, wherein the at least two second connection units are respectively connected to at least two second storage units.
